(19) United States
(12) Patent Application Publication
(10) Pub. No.: US 2010/0166075 A1
(43) Pub. Date: Jul. 1, 2010

(54) METHOD AND APPARATUS FOR CODING VIDEO IMAGE

(75) Inventors: Chang-Hyun LEE, Gyeonggi-do (KR); Kwang-Pyo CHOI, Gyeonggi-do (KR); Yong-Serk KIM, Seoul (KR); Young-Hun JOO, Gyeonggi-do (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/649,467

(22) Filed: Dec. 30, 2009

(30) Foreign Application Priority Data
Dec. 30, 2008 (KR) 10-2008-0137443

(51) Int. Cl. H04N 11/02

(52) U.S. Cl. 375/240.16; 375/E07.026

(57) ABSTRACT

A method and apparatus for coding a video image is provided, in which a first macro block is coded with intra coding modes, the number of which corresponds to the first macro block, a first intra coding mode having a minimum value and a first minimum value to which the first intra coding mode is applied are acquired, the first minimum value is compared with a threshold that is set for fast coding mode search, and it is determined whether to code a second macro block with intra coding modes, the number of which corresponds to the second macro block, based on the comparison.

### CROSS-REFERENCE TO RELATED APPLICATION

This application claims benefit of a Korean Patent Application filed in the Korean Intellectual Property Office on Dec. 30, 2008 and assigned Serial No. 10-2008-0137443, the entire disclosure of which is hereby incorporated by reference.

### BACKGROUND

1. Field

The exemplary embodiments relate generally to coding a video image, and more particularly, to a method and apparatus for coding a video image through fast intra mode search.

2. Description of the Related Art

Recently, transmission of multimedia in network environments is being widely used. Among the multimedia, video images occupy a large bandwidth in multimedia communications. In this connection, many compression technologies have been proposed to enable higher quality at a higher rate.

H.264/MPEG-4 Advanced Video Coding (H.264/AVC) is one of the video image compression standards. H.264/AVC, one of the conventional coding technologies such as MPEG-1, MPEG-2 and MPEG-4, aims to provide high efficiency coding using an intra coding mode and an inter coding mode.

The intra coding mode is a technology for performing coding based on the fact that the spatial correlation is high within one image. This technology generates prediction data using neighboring blocks in the current image block and then removes spatial redundancy. On the other hand, the inter coding mode is a technology for performing coding based on the fact that the temporal correlation is high between adjacent images. This technology generates prediction data using a previous or subsequent image of the current image and then eliminates temporal redundancy. Generally, the inter coding mode accurately generates prediction data using an interpolation filter before searching for prediction blocks.

However, the H.264/AVC codec, which has provided the highest-ever video compression efficiency, has high power consumption because of its high computational complexity. In particular, the H.264/AVC codec generally performs an operation with an intra 4×4 coding mode and then determines an operation of an intra 16×16 coding mode. Given that the operation corresponding to the number of intra 4×4 coding modes is more complex, this method is ineffective. In the case where a coding mode is determined using a motion vector acquired in a motion compensation process, i.e. an intra mode in a reference image indicated by a motion vector is utilized, if a field indicated by the motion vector is a padding field or an error difference with the current image block is significant, the application may be limited.

Therefore, there is a need for an intra coding mode search scheme for ensuring the same coding efficiency with the lower computational complexity, for video image coding.

### SUMMARY

An aspect is to address at least the above-mentioned problems and/or disadvantages and to provide at least the advantages described below. Accordingly, an aspect provides a method and apparatus for generating a prediction block by fast intra coding mode searching during video image coding.

Another aspect provides a method and apparatus for coding a video image by performing an intra coding mode in which a characteristic of an input video image is reflected.

A further another aspect provides a method and apparatus for coding a video image with faster intra coding modes by preferentially performing intra coding modes having a low computational complexity among intra coding modes having different macro block sizes.

Yet another aspect provides a video image coding method and apparatus for ensuring the same coding efficiency while preferentially performing intra 16×16 coding modes.

In accordance with one aspect, there is provided a method for coding a video image. The method includes coding a first macro block with intra coding modes, the number of which corresponds to the first macro block, and acquiring a first intra coding mode having a minimum value and a first minimum value, i.e., the lowest first value, to which the first intra coding mode is applied; comparing the first minimum value with a threshold that is set for fast coding mode search; and determining whether to code a second macro block with intra coding modes, the number of which corresponds to the second macro block, based on the comparison.

In accordance with another aspect, there is provided an apparatus for coding a video image. The apparatus includes a prediction block generator including a threshold setter for storing a threshold that is set for fast coding mode search; a comparator for coding a first macro block with intra coding modes, the number of which corresponds to the first macro block, acquiring a first intra coding mode having a minimum value and a first minimum value to which the first intra coding mode is applied, comparing the first minimum value with the threshold, and determining whether to code a second macro block with intra coding modes, the number of which corresponds to the second macro block, based on the comparison; and an intra prediction block selector for generation an intra prediction block according to the comparison result from the comparator.

### BRIEF DESCRIPTION OF THE DRAWINGS

The above and other aspects and features of certain exemplary embodiments will be more apparent from the following description taken in conjunction with the accompanying drawings, in which:

FIG. 1 is a diagram showing an image slice and image blocks defined with regard to video image coding according to an exemplary embodiment;

FIG. 2 is a flowchart showing a process of setting a threshold Ecost for fast intra mode search according to an exemplary embodiment;

FIG. 3 is a flowchart showing an intra coding prediction process to which fast intra modes are applied according to an exemplary embodiment;

FIG. 4 is a flowchart showing an operation of generating prediction blocks through fast coding mode search in a video image coding apparatus according to an exemplary embodiment; and

FIG. 5 is a diagram showing a structure of a video image coding apparatus according to an exemplary embodiment.

Throughout the drawings, the same drawing reference numerals will be understood to refer to the same elements, features and structures.

### DETAILED DESCRIPTION OF EXEMPLARY EMBODIMENTS

The following description with reference to the accompanying drawings is provided to assist in a comprehensive understanding of exemplary embodiments as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

Exemplary embodiments will now be described in detail with reference to the accompanying drawings.

The exemplary embodiment first searches for an intra 16×16 coding mode for video image coding, and determines whether to search for an intra 4×4 coding mode using the minimum Cost 16×16 value among the intra 16×16 coding mode search results, i.e., the lowest Cost 16×16 value. The intra 16×16 coding modes, which are simple when compared with the intra 4×4 coding modes with a high computational complexity, are first performed, thereby supporting fast coding mode search while ensuring the same coding efficiency.

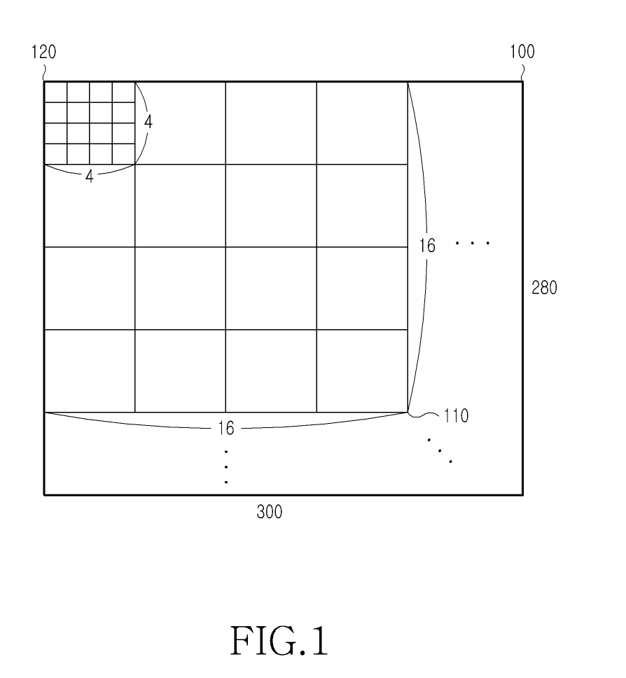

FIG. 1 shows an image slice 100 and image blocks defined for video image coding according to an exemplary embodiment.

Referring to FIG. 1, an image slice 100 is roughly divided into three types: I-slice, P-slice and B-slice. I-slice means one image frame that is independently compressed, and it is coded by applying intra coding modes having a high spatial correlation. P-slice means an image frame in which only the difference between the current image and its previous image is compressed. Therefore, I-slice is greater than P-slice in image or data size. Meanwhile, B-slice means an image frame in which a difference between forward and reverse images is compressed. The P-slice and B-slice undergo coding by applying inter coding modes having a high temporal correlation.

One image slice 100 has a size of 320×280, 640×480, etc., and is a set of multiple pixels. The image slice 100 may be divided into multiple Macro Blocks (MBs) having sizes of 16×16, 16×8, 8×16, 8×8, 8×4, 4×8, 4×4, etc. The MB means a basic unit of a coding process for an image block, i.e., a set of pixels of a predetermined size. For convenience, the term ‘image block’ used herein indicates an MB of a predetermined size. Although not specified here, if an image complexity of an input slice is low, the input slice may be divided into MBs of a size greater than 16×16, for example, MBs of a size of 32×32.

Meanwhile, an MB may be coded with a coding mode that is different depending on a predetermined size. For example, a 16×16 MB 110 may be coded by applying four kinds of intra coding modes such as horizontal, vertical, left diagonal, and right diagonal. A 4×4 MB 120 may undergo coding by applying nine kinds of intra coding modes such as horizontal, vertical, left diagonal, right diagonal, twister, lattice, etc.

As a result, for each MB, intra coding modes, the number of which corresponds to its MB size, are applied and then a coding mode with the minimum error difference is determined as the best mode of the MB. Therefore, a 4×4 MB having nine kinds of coding modes is generally higher in computational complexity than a 16×16 MB having four kinds of coding modes.

Meanwhile, an intra predictor intends to support faster intra modes by performing a quantization process before determining the best mode for an MB of a particular size. In this regard, the quantization will be described in brief.

An MB of the predetermined size is transmitted through quantization to more efficiently use limited wireless resources. More specifically, for a particular image block, spectral data output from a frequency converter (or Discrete Cosine Transform (DCT) converter) is mapped to a specific scalar value by a Quantization Parameter (QP) during its delivery.

For example, assuming that for an image block to be transmitted, a QP value of 10 is applied, if spectral data has ranges of 0-9, 10-19, 20-29, . . . , 91-100, spectral data within the range of 0-9 is mapped to a scalar value ‘0’ and spectral data within the range of 10-19 is mapped to a scalar value ‘1’. Therefore, a transmitting-side coding apparatus transmits the scalar value of ‘0’ or ‘1’, and a receiving-side decoding apparatus receives the scalar value of ‘0’ or ‘1’, and dequantize the received scalar value, thereby restoring the image block. However, when the decoding apparatus performs decoding, the scalar value ‘0’ may not be restored to ‘0’, even though actually it is spectral data within a range of 0-9, thus causing an increase in data loss between the transmitted image block and the image block interpolated in the receiving side.

In other words, in terms of using the limited wireless resources, an increase in the QP value may advantageously decrease a bit rate for data transmission, but may disadvantageously increase data loss during restoration of an image block. However, a decrease in the QP value disadvantageously increases a bit rate for data transmission, but may advantageously decrease quality change between the transmitted image block and the image block interpolated in the receiving side. Therefore, in terms of coding, it is important to set a proper QP value taking into account bit rate efficiency and data loss.

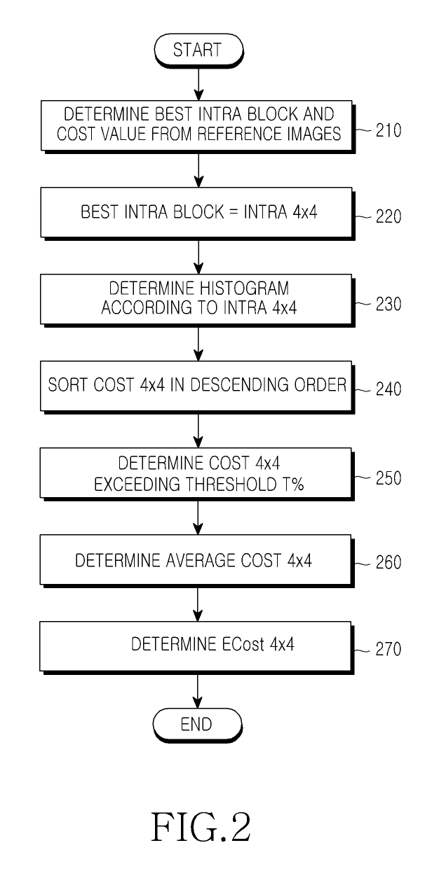

FIG. 2 shows a process of setting a threshold Ecost for fast intra mode search according to an exemplary embodiment.

Referring to FIG. 2, in operation 210, an intra predictor acquires the best intra block and coding mode determined for each MB, using test images stored for motion estimation and compensation of a video image. For example, the intra predictor uses reference images such as akiyo, container, crew, foreman and stefan, as test images. For example, ‘foreman’ is an image frame containing a worker at a worksite that people can often see. That is, the test images are images, to which reference is made in order to compare the time required for predicting coding modes of an image block to be coded, and a Peak Signal to Noise Ratio (PSNR) with the image block.

Therefore, in operation 210, the intra predictor divides the reference images into MBs of predetermined sizes of 16×16, 16×8, 8×16, 8×8, 8×4, 4×8 and 4×4, and then determines the best intra coding block and a Cost value corresponding to each MB by applying determined coding modes to the MBs.

In operation 220, the intra predictor determines whether the best intra MB with a Cost value is an intra 4×4 MB. In operation 230, the intra predictor applies nine kinds of coding modes to the intra 4×4 MB, and acquires Cost 4×4 values, which are the coding mode application results. The Cost 4×4 values for the respective coding modes may be acquired in the form of a histogram.

In operation 240, the intra predictor sorts the acquired Cost 4×4 values in descending order.

In operation 250, the intra predictor determines Cost 4×4 values greater than a threshold T that is set in view of a quantization value of the MB, among the Cost 4×4 values sorted in descending order. The reason for making comparison with the threshold T is to delete image information leaving a predetermined range, i.e., located in the boundary of one image slice, among the information quantized according to the quantization value for faster intra coding mode search.

In operation 260, the intra predictor calculates an average of intra Cost 4×4 values greater than the threshold T for coding mode sorting. That is, the intra predictor acquires an average intra Cost 4×4 value.

In operation 270, the intra predictor sets the acquired average Cost 4×4 value as an ECost 4×4 value to apply fast intra coding modes according to the exemplary embodiment. The ECost 4×4 value defined according to the exemplary embodiment is a threshold that is defined to first calculate intra 16×16 coding modes, skipping intra 4×4 coding modes having a high computational complexity for an input image.

Therefore, the intra predictor performs faster intra mode search on the input image using the acquired ECost 4×4 value. Equation (1) below is a function expression for a QP value, for T=10%.

ECost 4×4(QP)=a0+a1·QP+a2·QP2+a3·QP3 (1)

where respective coefficients are as follows:

a0=89.143

a1=55.143

a2=−3.0857

a3=0.08

If the T increases, the calculation process is reduced, contributing to a decrease in power consumption by calculation, but coding efficiency of a coder is reduced disadvantageously. That is, there is a trade-off between the computational complexity and the coding efficiency. Therefore, setting a proper T for each QP is a basis for fast intra coding mode search by adjusting the trade-off.

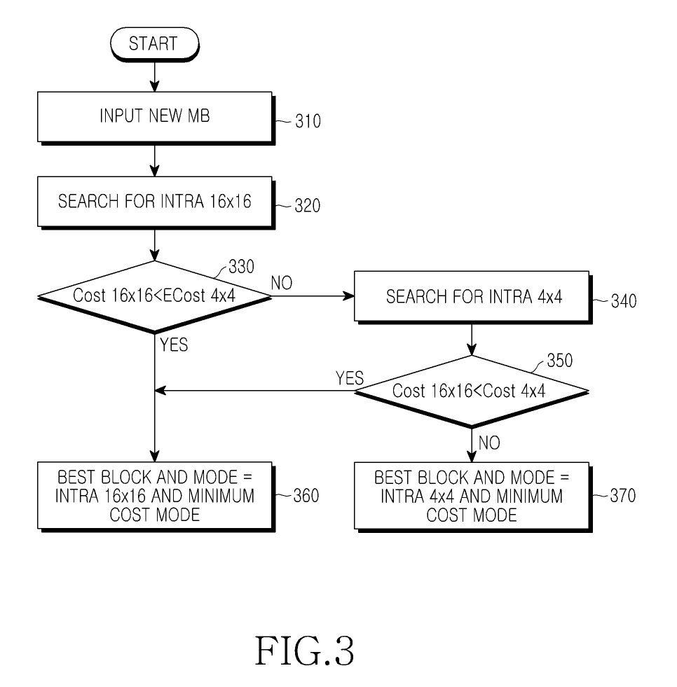

FIG. 3 shows an intra coding prediction process to which fast intra modes are applied according to an exemplary embodiment.

Referring to FIG. 3, if an image to be coded is input, the intra predictor divides the input image into 16×16 MBs and codes them in operation 310. Regarding the coding, the input image may be divided into MBs having predetermined sizes of 16×16, 4×4, etc. That is, an input image may have high coding efficiency with a large coding mode prediction time difference for a predetermined MB. On the other hand, the input image may have the same or similar coding efficiency with a very small coding mode prediction time difference.

For example, in case of an input image containing a speck of white cloud in the blue sky, a coding efficiency difference is not significant according to sizes of divided MBs, because pixels containing information have characteristics of flat areas as they have similar chrominance and luminance in one image frame. Meanwhile, in case of an input image of a flower garden where there is a number of small violet flowers, a coding efficiency difference may be significant according to sizes of divided MBs. Therefore, in operation 310, the intra predictor includes changing a size of MBs considering characteristics of the input image and coding the size-changed MBs.

In operation 320, the intra predictor searches for intra coding 16×16 values by applying four kinds of coding modes to 16×16 MBs. Therefore, the intra predictor acquires a Cost 16×16 value for each of the four kinds of coding modes.

In operation 330, the intra predictor compares an ECost 4×4 value or a threshold that is set for fast intra coding mode search, with a Cost 16×16 value having the minimum value among the acquired Cost 16×16 values. If the Cost 16×16 value is less than the threshold or the Ecost 4×4 value, the intra predictor proceeds to operation 360.

In operation 360, the intra predictor determines the minimum Cost 16×16 value as the best intra coding 16×16 mode for an intra prediction block, and stores the minimum intra Cost 16×16 value.

However, if the minimum Cost 16×16 value is greater than the threshold or the Ecost 4×4 value in operation 330, the intra predictor searches for intra coding 4×4 modes by applying nine kinds of coding modes after dividing the input image into 4×4 MBs in operation 340. The intra predictor determines Cost 4×4 values according to coding modes.

If the Cost 16×16 value has the same value as the threshold or the Ecost 4×4 value, the intra predictor may proceed to either operation 340 or operation 360. If the input image has characteristics of flat areas, there is no significant error difference between a prediction block to which 16×16 coding modes are applied, and a prediction block to which 4×4 coding modes are applied. Therefore, for faster coding mode search, it is preferable to proceed to operation 360. For an image block requiring more accurate coding, it is preferable to proceed to 340.

In operation 350, the intra predictor compares a Cost 4×4 value having the minimum value among the determined Cost 4×4 values, i.e., the lowest Cost 4×4 values, with a Cost 16×16 value having the minimum value. If the minimum Cost 16×16 value is less than the minimum Cost 4×4 value, the intra predictor proceeds to operation 360. However, if the minimum Cost 4×4 value is less than the minimum Cost 16×16 value, the intra predictor proceeds to operation 370. If the minimum Cost 16×16 value is equal to the minimum Cost 4×4 value, the intra predictor may proceed to either operation 360 or operation 370.

In operation 370, the intra predictor determines the minimum Cost 4×4 value as the best intra coding 4×4 mode for an intra prediction block, and stores the minimum intra Cost 4×4 value.

As described above, performing accurate prediction means applying a variety of coding modes to MBs of a smaller size. However, generating a prediction block by applying coding modes to all input image blocks, for example, 4×4 MBs, may serve as disadvantage in terms of the computational complexity. Therefore, the exemplary embodiment first searches for intra 16×16 coding modes, and then determines whether to search for intra 4×4 coding modes using the minimum Cost 16×16 value among the search results, thereby determining the best intra coding modes for a shorter coding mode prediction time.

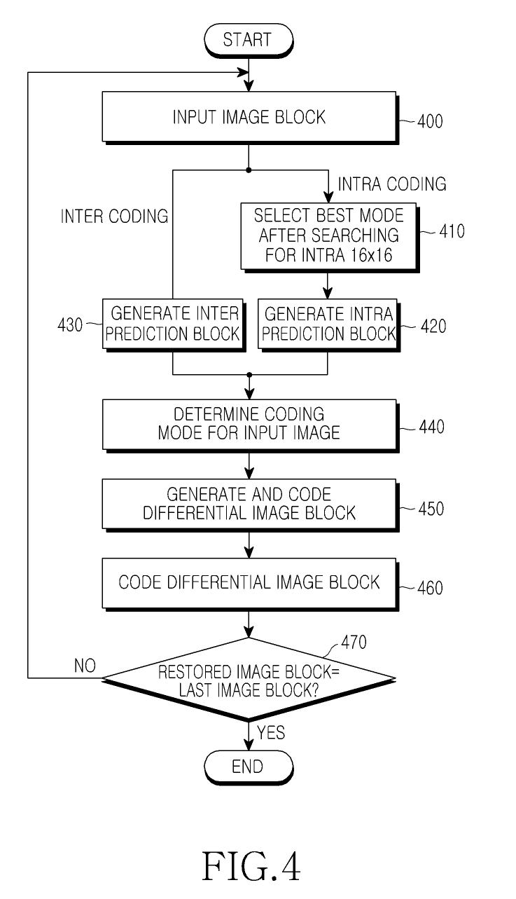

FIG. 4 shows an operation of generating prediction blocks through fast coding mode search in a video image coding apparatus according to an exemplary embodiment.

Referring to FIG. 4, an image input unit inputs an image slice to be transmitted on a predetermined image block basis in operation 400.

In operation 410, a prediction block generator first searches for intra 16×16 coding modes for the currently input image block as shown in FIG. 3. The prediction block generator determines Cost 16×16 values for the respective intra 16×16 coding modes, and compares them with an ECost 4×4 value or a threshold that is set for fast intra mode search to determine the minimum intra 16×16 coding mode or the minimum intra 4×4 coding mode. The prediction block generator determines the best intra coding mode by comparing the blocks predicted using the minimum intra 16×16 coding mode or the minimum intra 4×4 coding mode.

In operation 420, the prediction block generator generates an intra prediction block using the intra coding modes determined in operation 410. That is, the prediction block generator generates an intra prediction block by applying the best intra coding mode to a reference image block that is expected to have the highest spatial correlation with respect to the current input image block and has been decoded and stored.

In operation 430, the prediction block generator performs interpolation using an interpolation filter that is set considering the current input image block, and generates an inter prediction block having the minimum error with the current input image block.

In operation 440, the prediction block generator compares the inter prediction block with the intra prediction block, and selects a prediction block having the higher coding efficiency. Therefore, the prediction block generator determines a coding mode having the higher coding efficiency as a coding mode for the input image block. That is, the prediction block generator determines whether it will code the input image block by applying the inter coding mode or by the intra coding mode.

In operation 450, a differential image block generator generates a differential image block between the prediction block generated by the prediction block generator and the current image block. Specifically, the differential image block refers to an image block consisting of a residual signal corresponding to a pixel difference between the current input image block and the prediction block generated based on the coding mode determined among the intra coding mode or the inter coding mode in the prediction block generator.

In operation 460, a differential image block decoder performs decoding on the differential image block. The differential image block decoder generates a reference image block for an image block to be input next by reconstructing the differential image block. The generated reference image block is stored in a separate frame storage.

In operation 470, the prediction block generator determines whether the restored image block is the last image block in the current input slice. Based on the determination results, the prediction block generator repeatedly performs operations 400 to 470, or ends the coding process on the entire current input image slice.

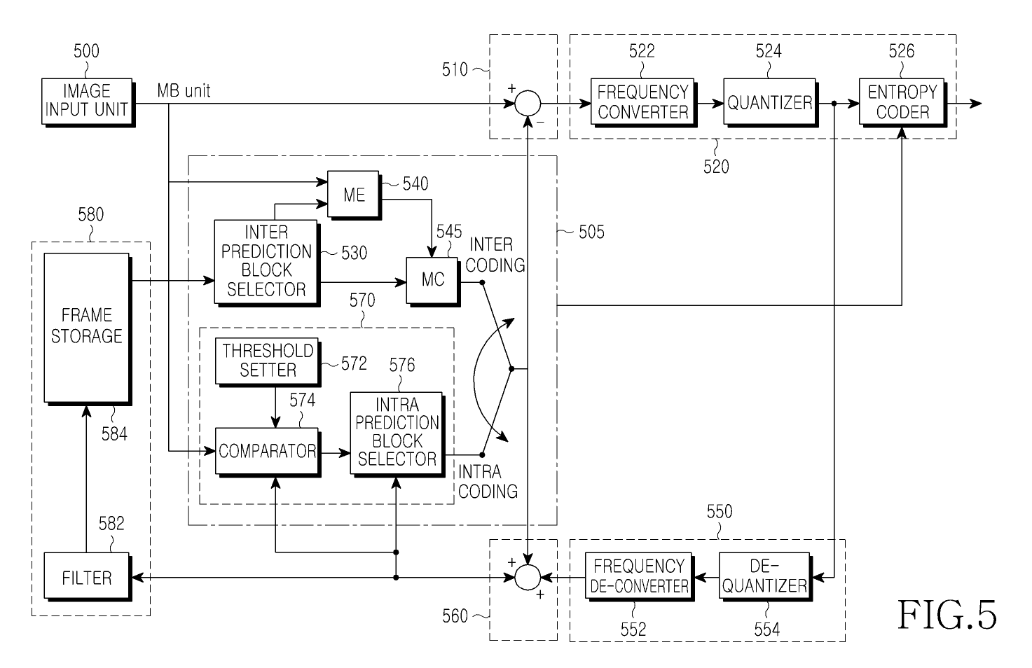

FIG. 5 shows a structure of a video image coding apparatus according to an exemplary embodiment.

Referring to FIG. 5, the video image coding apparatus includes an image input unit 500, a prediction block generator 505, an image block generator 510, a differential image block coder 520, a differential image block decoder 550, an image block restorer 560, and a reference image block data generator 580.

The image input unit 500 inputs one image among I-slice, P-slice and B-slice that are separated according to slice types. The input slice is processed in units of MBs, which are predetermined image processing block units of 16×16, 16×8, . . . , and 4×4.

The image block generator 510 generates a differential image block by combining the image block received in a predetermined MB size with a prediction block having the minimum inter-image error with the current image block, which is output from the prediction block generator 505. In brief, the prediction block generator 505 generates a prediction block by applying a coding mode having a higher coding efficiency among an intra coding mode and an inter coding mode, to a reference image block that was coded by the differential image block coder 520 and decoded by the differential image block decoder 550, and outputs the generated prediction block. Therefore, the image block generator 510 performs more accurate coding using the prediction block output from the prediction block generator 505.

The differential image block coder 520 includes a frequency converter 522, a quantizer 524, and an entropy coder 526.

The frequency converter 522 converts information about pixels of a spatial-domain input image block into frequency-domain spectral data. The frequency converter 522 normally performs Discrete Cosine Transform (DCT) and generates a DCT coefficient block on an MB basis.

The quantizer 524 quantizes a block of spectral data coefficients output from the frequency converter 522. The quantizer 524 may perform quantization by applying a specific scalar value to the spectral data in a step size that varies considering a slice type of the input image. In the exemplary embodiment, the quantizer 524 may perform quantization by applying a QP value to the spectral data in a step size that varies considering a slice type of the image and characteristics of MBs constituting the image. The quantizer 524 varies the QP value considering a target bit rate to be compressed based on the current wireless channel environment or considering the fixed coder's bit rate.

The entropy coder 526 compresses information output from the quantizer 524, including a slice type of the image and contextual information of MBs. The entropy coder 526 may be implemented by arithmetic coding, Huffman coding, run-length coding, etc. The entropy coder 526 stores the compressed image information, and outputs the image information considering a set bit rate.

The differential image block decoder 550 is adapted to generate an inverse differential image block by performing decoding on the differential image block generated by the differential image block coder 520. The differential image block decoder 550 includes a de-quantizer 554 and a frequency de-converter 552. The de-quantizer 554 performs de-quantization using the step size quantized by the QP value of the quantizer 524. The frequency de-converter 552, which performs an inverse operation of the frequency converter 522, generates an inverse differential image block by inverse DCT conversion. Between the inverse differential image block output from the frequency de-converter 552 and the differential image block generated by the differential image block generator 510, data loss may occur according to the CP value applied to the quantization process 524 and the de-quantization process 554. Therefore, it is necessary to adaptively apply the QP value considering image characteristics of the input image block.

The image block restorer 560 generates more accurate reference image blocks by comparing the inverse differential image block with the differential image block generated by the differential image block generator 510.

The reference image block data generator 580 includes a frame storage 584 and a filter 582. The filter 582 filters distorted reference image blocks among the reference image blocks generated by the image block restorer 560, because the reconstructed reference image blocks are distorted image data in the original input image block. The frame storage 584, which is adapted to store the reconstructed image blocks to predict the next frame, stores reference image blocks, discontinuity of which is removed by the filter 582. The reference image blocks are reconstructed image blocks applied to the next input image block.

In accordance with the exemplary embodiment, the prediction block generator 505 includes an inter predictor (530, 540 and 545) for, upon receiving an image block to be coded, generating a prediction block using inter coding modes taking characteristics of the current image block into consideration, and an intra predictor 570 for generating a prediction block using intra coding modes.

The intra predictor 570 includes a threshold setter 572, a comparator 574, and an intra prediction block selector 576.

The threshold setter 572 stores a threshold, or an ECost 4×4 value, that has been previously calculated for fast coding mode search using test images. In the exemplary embodiment, the threshold setter 572 extracts reference images considered to have the highest spatial correlation to the current input image block from among the reference image blocks stored in the frame storage 584, without using separate reference images, and applies coding modes corresponding to a predetermined size to the extracted reference blocks, thereby acquiring intra coding Cost values. The threshold setter 572 may acquire an average coding Cost value using the acquired Cost values, and set a threshold for fast coding mode search using the average coding Cost value. Therefore, it is possible to continuously update the threshold according to the input image block.

The comparator 574 searches for intra coding 16×16 modes by applying four kinds of coding modes to the current input image block of a 16×16 MB. That is, the comparator 574 supports fast coding mode search with the lower computational complexity corresponding to the four kinds of coding modes. The comparator 574 determines Cost 16×16 values corresponding to the four kinds of coding modes. The comparator 574 compares the minimum Cost 16×16 value among the determined Cost 16×16 values, with the threshold stored in the threshold setter 572.

The intra prediction block selector 576 determines intra coding 16×16 modes corresponding to the minimum Cost 16×16 value depending on the comparison results of the comparator 574. Also, the intra prediction block selector 576 determines intra coding 4×4 modes corresponding to the minimum Cost 4×4 value by applying nine kinds of 4×4 coding modes based on the comparison results.

In this way, the intra prediction block selector 576 generates intra coding 16×16 prediction blocks and intra coding 4×4 prediction blocks by applying the intra coding 16×16 modes and the intra coding 4×4 modes. The intra prediction block selector 576 selects a prediction block having a high coding efficiency, i.e., having a small error difference with the input image block, as a final intra prediction block, by comparing the generated prediction blocks.

Meanwhile, an inter prediction block selector 530 constituting the inter predictor performs interpolation processing on the minimum reference image block using an interpolation filter corresponding to the image block to be coded. The inter prediction block selector 530 repeatedly performs the interpolation operation until an error between the interpolated reference image block and the coded current image block is minimized. The inter prediction block selector 530 generates more accurate inter prediction blocks by increasing a pixel accuracy of the reference image blocks through the repeated interpolation processing.

A motion estimator (ME) 540 estimates a motion depending on the interpolated reference image block and the input image block. A motion compensator (MC) 545 performs motion compensation by applying a predetermined motion vector to each MB, and finally generates an inter prediction block. The motion estimator 540 and the motion compensator 545 may perform motion estimation and compensation on the intra prediction blocks generated by the intra predictor 570.

In sum, the prediction block generator 505 compares the intra prediction block generated by intra coding with the inter prediction block generated by inter coding, and outputs the prediction block having a high coding efficiency, i.e., having the minimum error difference with the current input image block, as a final prediction block.

Accordingly, the image block generator 510 generates a differential image block by combining the input image with the final prediction block, and the differential image block coder 520 codes the differential image block and transmits the coded differential image block to a video image decoding apparatus.

As is apparent from the foregoing description, an exemplary embodiment analyzes characteristics of an input image and preferentially performs intra 16×16 coding modes having a low computational complexity, while ensuring the same coding efficiency. In addition, the exemplary embodiment may first search for the intra coding modes having a low computational complexity taking into account various quantization values of the input image block.

In conclusion, the exemplary embodiment provides an average calculation efficiency of 44.0% compared to the conventional intra coding calculation, while ensuring the same coding efficiency and an error difference of about 1% or below on average.

While the exemplary embodiments has been shown, it will be understood by those skilled in the art that various changes in form and details may be made therein without departing from the spirit and scope of the invention as defined by the appended claims and their equivalents.

What is claimed is:

1. A method for coding a video image, comprising:
coding a first macro block with a first plurality of intra coding modes, a number of the first plurality of intra coding modes corresponding to the first macro block, and determining a first intra coding mode of the plurality of intra coding modes having a lowest first value;
comparing the lowest first value with a threshold for fast coding mode search; and
determining whether to code a second macro block with a second plurality of intra coding modes, a number of the second plurality of intra coding modes corresponding to the second macro block, based on the comparing.

2. The method of claim 1, further comprising, if the lowest first value is less than the threshold, generating an intra prediction block using the first intra coding mode.

3. The method of claim 2, further comprising:
if the lowest first value is greater than the threshold, coding the second macro block with the second plurality of intra coding modes, and determining a second intra coding mode of the second plurality of intra coding modes having a lowest second value;
comparing the lowest first value with the lowest second value; and
if the lowest first value is less than the lowest second value, generating the intra prediction block using the first intra coding mode.

4. The method of claim 3, further comprising, if the lowest first value is greater than the lowest second value, generating the intra prediction block using the second intra coding mode.

5. The method of claim 1, wherein a size of the first macro block is greater than a size of the second macro block.

6. The method of claim 5, wherein the first macro block is a 16×16 macro block and the first plurality of intra coding modes comprises four intra 16×16 coding modes, and the second macro block is a 4×4 macro block and the second plurality of intra coding modes comprises nine intra 4×4 coding modes.

7. The method of claim 6, further comprising generating an intra prediction block,
wherein the coding comprises calculating four 16×16 cost values by applying the four intra 16×16 coding modes to the 16×16 macro block,
wherein the determining the first intra coding mode comprises determining a lowest 16×16 cost value from among the four 16×16 cost values, as the lowest first value, and
wherein the comparing comprises comparing the lowest 16×16 cost value with the threshold,
if the lowest 16×16 cost value is less than the threshold, determining a coding mode corresponding to the lowest 16×16 cost value as the first intra coding mode and generating the intra prediction block using the first intra coding mode.

8. The method of claim 7, further comprising:
if the lowest 16×16 cost value is greater than the threshold, calculating nine 4×4 cost values by applying the nine intra 4×4 coding modes to the 4×4 macro block;
determining a lowest 4×4 cost value from among the nine 4×4 cost values;
comparing the lowest 16×16 cost value with the lowest 4×4 cost value;
if the lowest 16×16 cost value is less than the lowest 4×4 cost value, determining a coding mode corresponding to the lowest 16×16 cost value as the first intra coding mode and generating the intra prediction block using the first intra coding mode.

9. The method of claim 8, further comprising:
if the lowest 16×16 cost value is greater than the lowest 4×4 cost value, determining a coding mode corresponding to the lowest 4×4 cost value as the second intra coding mode and generating the intra prediction block using the second intra coding mode.

10. The method of claim 9, further comprising:
generating a differential image block by combining the intra prediction block with the image block;
converting the differential image block into spectral data;
quantizing the spectral data by applying a quantization value determined according to a size of a macro block of the image block; and
coding information about the quantized spectral data.

11. The method of claim 1, wherein the threshold set for fast coding mode search is an average coding value determined by:
coding test images with the second plurality of intra coding modes to generate coding result values;
sorting the coding result values in descending order;
detecting coding result values greater than a reference value T that is set based on a quantization value of the video image, among the coding result values sorted in descending order; and
determining an average coding value for the detected coding result values greater than the reference value T.

12. An apparatus for coding a video image, comprising:
a prediction block generator comprising;
a threshold setter which stores a threshold for fast coding mode search;
a comparator which codes a first macro block with a first plurality of intra coding modes, a number of the plurality of intra coding modes corresponding to the first macro block, determining a first intra coding mode of the plurality of intra coding modes having a lowest first value, compares in a comparison, the lowest first value with the threshold, and determines whether to code a second macro block with a second plurality of intra coding modes, a number of the second plurality of intra coding modes corresponding to the second macro block, based on the comparison; and
an intra prediction block selector which generates an intra prediction block according to a result of the comparison from the comparator.

13. The apparatus of claim 12, wherein the intra prediction block selector generates the intra prediction block using the first intra coding mode upon detecting a result of the comparison from the comparator, which indicates that the lowest first value is less than the threshold.

14. The apparatus of claim 13, wherein upon determining that the lowest first value is greater than the threshold, the comparator codes the second macro block with the second plurality of intra coding modes, determines a second intra coding mode of the second plurality of intra coding modes having a lowest second value, and compares the lowest first value with the lowest second value; and
wherein the intra prediction block selector generates the intra prediction block using the first intra coding mode, upon detecting the result of the comparison from the comparator, which indicates that the lowest first value is less than the lowest second value.

15. The apparatus of clam 14, wherein the intra prediction block selector generates the intra prediction block using the second intra coding mode, upon detecting the result of the comparison from the comparator, which indicates that the lowest first value is greater than the lowest second value.

16. The apparatus of claim 12, wherein a size of the first macro block is greater than a size of the second macro block.

17. The apparatus of claim 16, wherein the first macro block is a 16×16 macro block and the first plurality of intra coding modes comprises four intra 16×16 coding modes, and the second macro block is a 4×4 macro block and the second plurality of intra coding modes comprises nine intra 4×4 coding modes.

18. The apparatus of claim 17, wherein the comparator calculates four 16×16 cost values by applying the four intra 16×16 coding modes to the 16×16 macro block, determines a lowest 16×16 cost value from among the four 16×16 cost values, and compares the lowest 16×16 cost value with the threshold; and
wherein upon detecting the result of the comparison from the comparator, which indicates that the lowest 16×16 cost value is less than the threshold, the intra prediction block selector determines a coding mode corresponding to the lowest 16×16 cost value as the first intra coding mode, and generates the intra prediction block using the first intra coding mode.

19. The apparatus of claim 18, wherein upon determining that the lowest 16×16 cost value is greater than the threshold, the comparator calculates nine 4×4 cost values by applying the nine intra 4×4 coding modes to the 4×4 macro block, determines a lowest 4×4 cost value from among the nine 4×4 cost values, and compares the lowest 16×16 cost value with the lowest 4×4 cost value; and
wherein upon detecting the result of the comparison from the comparator, which indicates that the lowest 16×16 cost value is less than the lowest 4×4 cost value, the intra prediction block selector determines a coding mode corresponding to the lowest 16×16 cost value as the first intra coding mode, and generates the intra prediction block using the first intra coding mode.

20. The apparatus of claim 19, wherein upon detecting the result of the comparison from the comparator, which indicates that the lowest 16×16 cost value is greater than the lowest 4×4 cost value, the intra prediction block selector determines a coding mode corresponding to the lowest 4×4 cost value as the second intra coding mode, and generates the intra prediction block using the second intra coding mode.

21. The apparatus of claim 20, further comprising:
an image block generator which generates a differential image block by combining the intra prediction block with the image block;
a frequency converter which converts the differential image block output from the image block generator into spectral data;
a quantizer which quantizes the spectral data from the frequency converter by applying a quantization value determined according to a size of a macro block of the image block; and
an entropy coder which codes information about the quantized spectral data from the quantizer.

22. The apparatus of claim 21, wherein the threshold setter codes test images with a second plurality of intra coding modes to generate coding result values, sorts the coding result values, detects coding result values greater than a reference value T that is set based on a quantization value of the video image, among the coding result values sorted in descending order, determines an average coding value for the detected coding result values greater than the reference value T, and sets the average coding value as the threshold.
